(19) United States
(12) Patent Application Publication
(10) Pub. No.: US 2008/0150957 A1
(43) Pub. Date: Jun. 26, 2008

(54) Process for Coding Infrared Images

(76) Inventor: Mario Cimbalista, Curitiba City (BR)

Correspondence Address: MATTHIAS SCHOLL, 14781 MEMORIAL DRIVE, SUITE 1319, HOUSTON, TX, 77079, US

(21) Appl. No.: 11/722,711

(22) PCT Filed: Sep. 22, 2005
(86) PCT No.: PCT/BR05/00201

§ 371 Date: Jun. 23, 2007

(30) Foreign Application Priority Data
Dec. 24, 2004 (BR) MU 8403235-9

(51) Int. Cl. G09G 5/02

(52) U.S. Cl. 345/589

(57) ABSTRACT

Coding process on original infrared images, generated in black and white, to codifying them in negative black, white with specific split colours consists on a process af getting original infrared images that, been produced in back and white, are ceded to negative is black, white with a split in specific celars in such a way to produce a great visualization contrast in sectors are parts of the photographed object indicating temperature changes.

This patent refers to a coding process on infrared images, which are usually generated on a black and white pattern, to code them into a negative black and white pattern with a color split separation in such a way that it can produce a great visualization contrast of parts or sectors of the photographed object indicating critical or important temperature changes.

Such images are produced by equipments called Infrared Cameras which are designed to detect infrared radiation emitted by any object and transform these information in human eye recognizable images and possible to be interpreted in any specific situation.

Being so, all images made by Infrared Cameras, digital or analogical, are coded initially to a values matrix that generates by electronic circuitry, black, white and gray images contained between the camera limits, independent on camera type or model with which they were produced, independent of the observed object type, mechanical, electrical, masonry, plastic, organic, biological, live organism or not.

The processing software applied to this images transforms this values matrix in different color tones that are more or less identifiable by the human eye and then make them a lot more easier to identify regions of increased temperatures. The present technical transforms the basic information produced by the Infrared Cameras, by matrix analogical or digital files, on color palettes mixed in such a way that the results are presented together integrating a negative black and white image with color scales. The images processed by this technical simulates the photographic X-Ray effect that provides a standardized way of view, universally recognizable, and includes different color scales attached to different temperature levels. A particular case of this technical involves the utilization of a single color scale for all the processed image.

The different color scales and the different colors proportions and densities applied to the images permits different levels of discrimination for more or less critical situations. The same image, submitted to different scales and or color palettes, will reveal or not the critic grade to the human eye. The main advantage of this processing technical is the excellent characterization and easy localization of the interest points or spots for, due to the palette division between inverted black white added to colors palettes, all reference areas are made clearer (explicit) in such a way that the color areas represents the interest temperatures and the inverted black and white (in negative) areas gives the exact relative localization of the interest area.

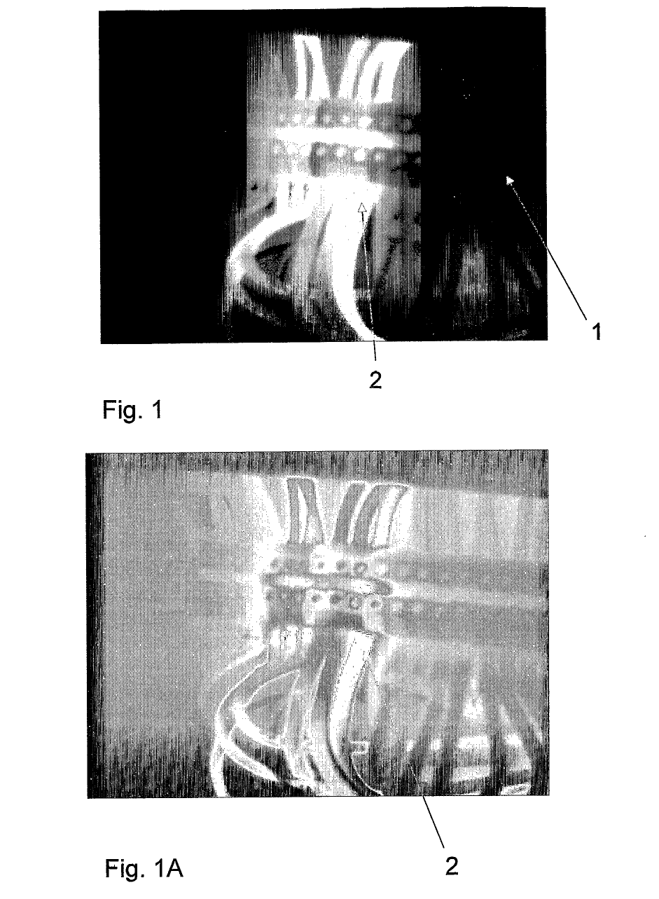

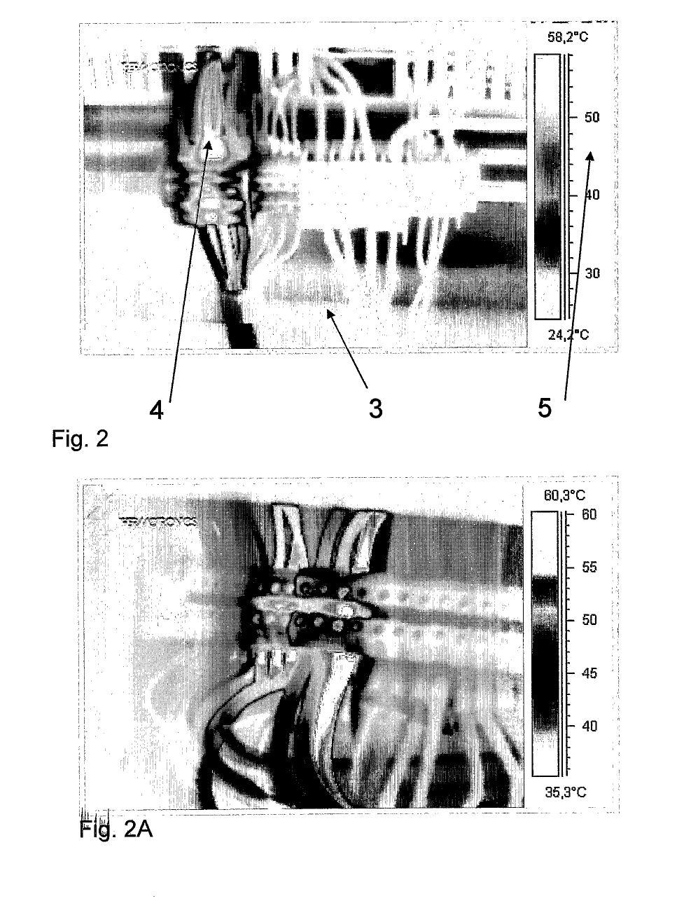

In the images attached to the present report, FIG. 1 presents the images generated by the usual Infrared Cameras available on the market without a software processing. The same occur to the FIG. 1A where a color palette without the inverted black and white mix. Fig. 2 presents the image generated by a software calibrated to process the color separation added with the inverted black and white (negative) only on the affected by thermal alteration, registered by a usual Infrared Cameras. The same is showed on FIG. 2A.

What we can see on the Fig. 1 for example, is a electrical component with some problem identified by the heating registered by a Infrared Cameras. Except of the defective component, the rest of the image is presented on a homogeneous dark gray scale tone, or similar. The contrast that shows the thermal differences is produced by common software available on the market that indicates brighter tones of gray, up to white, or hot color such as red, yellow or orange, all over the image. This coding is valid to any object on which a Infrared Cameras is aimed.

The process of this patent keeps, by modifications introduced on these software, the black and white (inverted or not) codification for the parts of the objects that doesn't show important thermal differences that can indicate an anomaly, processing, in contrast to this black and white (inverted or not) button palette, a color coding on the parts in which a thermal variation exists indicating anomalies that can be adjusted changing the intensity of the color saturation.

1. Coding process on original infrared images, generated In black and white. To codifying them in negative black, white With specific split colours is characterized by the process of insert alterations in software, or in dedicated software that generates infrared images, registered by infrared cameras, coded in black and white and gray grades applied to all parts of the objects registered by these cameras that do not show enough thermal variations that can indicate functional anomalies, processing, in contrast to this background, colors coding on the parts that shows thermal variations that indicates anomalies, adjusting the respective intensities by a color saturation device.
